(19) United States
(12) Patent Application Publication
(10) Pub. No.: US 2025/0140126 A1
(43) Pub. Date: May 1, 2025

(54) METHOD OF DYNAMICALLY GENERATING PERSONALIZED KNOWLEDGE GRAPH BASED ON PROMPT LEARNING

(71) Applicant: Xuzhou Medical University, Xuzhou (CN)

(72) Inventors: Xiang Wu, Xuzhou (CN); Mingzhao Yang, Xuzhou (CN); Jie Zu, Xuzhou (CN); Pei Li, Xuzhou (CN); Xin Liu, Xuzhou (CN); Zehua Yu, Xuzhou (CN); Yongting Zhang, Xuzhou (CN)

(21) Appl. No.: 19/004,222

(22) Filed: Dec. 28, 2024

(30) Foreign Application Priority Data
Jan. 8, 2024 (CN) 202410022372.8

(51) Int. Cl. G09B 17/00

(52) U.S. Cl. CPC G09B 17/003

(57) ABSTRACT

Provided is a method of dynamically generating a personalized knowledge graph based on prompt learning. The method includes the following steps: classifying a textbook difficulty to obtain textbook difficulty prompt words; extracting a learning target to obtain learning target prompt words; evaluating the learning ability of students to obtain a level of the learning ability of students; and generating a dynamic personalized knowledge graph according to prompt words selected by students, evaluation results of the learning ability and a set prompt mapping rule. The method evaluates the learning ability, and selects a course learning difficulty and a course learning target as required. The above steps are combined with subjectivity and passivity to integrally and dynamically generate personalized courses. Each class can make a selection, so as to meet ever-changing learning needs of the student.

### TECHNICAL FIELD

The present disclosure relates to a method of dynamically generating a personalized knowledge graph based on prompt learning.

### BACKGROUND

A traditional teaching mode has some disadvantages, such as ignoring individual differences of students, lacking personalized support and limiting initiative of students. Personalized teaching is student-centered, focusing on meeting learning needs of students and improving learning effects. The personalized teaching mode can better meet learning characteristics and needs of students, and cultivate the lifelong learning ability of students through personalized teaching resources, cultivation of autonomous learning and participation, and personalized feedback. The implementation of personalized teaching will provide students with more targeted and effective education, promote their all-round development and achieve better learning results.

A knowledge graph is a structured data model for representing and organizing knowledge, which describes the relationship between things in the form of a graphical network consisting of nodes and edges. The knowledge graph aims to integrate knowledge in various fields into a unified framework so that machines can understand and use such knowledge. The personalized knowledge graph constructs a personalized knowledge representation and organization manner for each learner based on the traditional knowledge graph in combination with the characteristics and needs of individual learners. The knowledge graph aims to provide personalized knowledge recommendation, learning path planning and intelligent tutoring according to factors of learners such as interests, abilities, learning processes.

The existing personalized knowledge graph is constructed by analyzing the learning behavior, interest preferences and learning feedback of learners. Although the personalized needs are met, the learning paths of students are fixed, which cannot be adjusted and selected independently, and cannot meet dynamic learning needs of students. Therefore, it is urgent to propose a method of generating a dynamically adjustable personalized knowledge graph.

### SUMMARY

The present disclosure aims to overcome the shortcomings in the prior art and provide a method of dynamically generating a personalized knowledge graph based on prompt learning.

In order to achieve the purpose of the present disclosure, the following technical scheme will be used for implementation.

A method of dynamically generating a personalized knowledge graph based on prompt learning is provided, including the following steps:
S1, constructing a prompt word library, wherein the prompt word library includes: difficulty prompt words, wherein the difficulty prompt words are indicated as primary, intermediate, advanced or extended; and learning target prompt words, wherein the learning target prompt words are indicated as understood, mastered, proficient or/and extended; wherein
the difficulty prompt words are obtained by the following steps:
S111, acquiring a target textbook and teaching plans of the target textbook from a teacher over the years;
S112, dividing textbook knowledge points according to the target textbook and the teaching plans;
S113, defining an importance and a calculating rule of the textbook knowledge points, a common sense and a calculating rule of the textbook knowledge points, and an emphasis and a calculating rule of the teaching plans;
S114, obtaining the importance of the textbook knowledge points, the common sense of the textbook knowledge points and the emphasis of the teaching plans according to the above calculating rules, and giving a difficulty classification of the textbook knowledge points: primary, intermediate, advanced or/and extended to obtain the difficulty prompt words;
the learning target prompt words are obtained by the following steps:
S121, acquiring the teaching plans of the target textbook from the teacher over the years;
S122, extracting a teaching target of each class hour in the teaching plan;
S123, converting the teaching target into a learning target to obtain learning target prompt words;
S2, evaluating the learning ability of students, wherein the evaluation method includes the following steps:
S211, acquiring a written score C_a, a usual score N_a and a self-evaluation S_e of students;
S212, calculating a learning ability score S_a of students through a set evaluation calculating rule;
S3: giving a knowledge graph of the class according to prompt words selected by students, learning ability results and a set prompt mapping rule; wherein the mapping rule includes a knowledge point linking method.

Further, as for the importance of the textbook knowledge points, the more writing length W of knowledge points in the target textbook and the more pictures P indicate the higher importance S of the knowledge points, and the calculating rule of the importance S is as follows:
given that the total length of the textbook is M, the total length of characters is T s and the total length of pictures is P_s, a writing length coefficient is

$$a = \frac{T\_s}{M} ,$$

and a picture proportion coefficient is

$$b = \frac{p\_s}{M} ;$$

if the writing length of a knowledge point is W, and the number of pictures is P, the importance of the knowledge point is: S=aW+bP;
as for the common sense of the textbook knowledge points, the knowledge points with a higher using frequency are more familiar in this field, the knowledge points are defined as commonsense knowledge points; otherwise, the knowledge points are advanced knowledge points; and the calculating rule of the common sense C is as follows:

$$C = \{ \begin{matrix}0 , commonsense knowledge points \\ 1 , advanced knowledge points\end{matrix} ;$$

as for the emphasis of the teaching plans, in the teaching plans from many teachers over the years, the knowledge points in which the writing length has a higher proportion and the class hour has a higher proportion are the emphasis, and the calculating rule of the emphasis E is as follows:
given that the total length of the teaching plan is M, the total number of class hours is T, the writing length of a knowledge point is m, and the number of the occupied class hours is t, the length proportion is

$$M\_p = \frac{m}{M} ,$$

the class hour proportion is

$$T\_p = \frac{t}{T} ,$$

and the emphasis of the knowledge point is E=0.5*M_p+0.5*T_p.

Further, a difficulty classifying standard of the textbook knowledge points is designed as follows:

$$\{ \begin{matrix}primary , C = 0 , Total ∈ [ 0 , 0.25 ] \\ i n t ermediate , C = 0 , Total ∈ ( 0.25 , 0.5 ] \\ advanced , C = 1 , Total ∈ ( 0.5 , 0.75 ] \\ extended , C = 1 , Total ∈ ( 0.75 , 1 ]\end{matrix} , where Total = \frac{S + E}{2} .$$

Further, the evaluation calculating rule is as follows: if the usual score accounts for 30%; the written score accounts for 60%, and the self-evaluation of the student accounts for 10%:

$$S\_a = 0 \text{.3} * N\_a + 0 \text{.6} * C\_a + 0 \text{.1} * S\_e ,$$

$$\{ \begin{matrix}low , S\_a ∈ [ 0 , 0.6 ] \\ intermediate , S\_a ∈ ( 0.6 , 0.75 ] . \\ high , {S}_{-} a ∈ ( 0.75 , 1 ]\end{matrix}$$

Further, the prompt mapping rule is designed as follows:
if a combination of the prompt words and the evaluation results is the permutation and combination of [primary, understood, low/intermediate/high], the knowledge points with primary difficulty level are directly selected to start, the knowledge graph of all primary knowledge points is generated according to the order of textbooks, and the combination of the prompt words and the learning time are recorded;
if the combination of the prompt words and the evaluation results is the permutation and combination of [intermediate, understood/mastered, intermediate/high], the knowledge graph is generated according to the knowledge point linking method, and the combination of the prompt words and the learning time are recorded;
if the combination of the prompt words and the evaluation results is the permutation and combination of [advanced, proficient/extended, high], the knowledge graph is generated according to the designed knowledge point linking method, and the combination of the prompt words and the learning time are recorded;
if the combination of the prompt words and the evaluation results is the permutation and combination of [extended, proficiency/extended, high], the knowledge graph is generated according to the designed knowledge point linking method, and the combination of the prompt words and the learning time are recorded;
if the prompt words and the evaluation results are other combinations than the above combination, students are advised to re-select or study in the order of textbooks, and the learning time is recorded.

Still further, the knowledge point linking method includes the following steps:
S611, counting the knowledge points to obtain a knowledge point set;
S612, classifying the knowledge points according to the difficulty level to obtain a primary knowledge point set P=[P₁, P₂, . . . , Pₚ], an intermediate knowledge point set I=[I₁, I₂, . . . , Iᵢ], an advanced knowledge point set A=[A₁, A₂, . . . , Aₐ], and an extended knowledge point set E=[E₁, E₂, . . . , Eₑ].
S613, calculating a frequency of the primary knowledge point P appearing in other knowledge points; similarly, calculating a frequency of the intermediate knowledge point I appearing in the advanced and extended knowledge points and a frequency of the advanced knowledge point A appearing in the extended knowledge points;
S614, linking the knowledge points according to a frequency result.

The present disclosure has the following beneficial effects. The present disclosure includes the following steps: classifying a textbook difficulty to obtain textbook difficulty prompt words; extracting a learning target to obtain learning target prompt words; evaluating the learning ability of students to obtain a level of the learning ability of students; and evaluating the ability of students, and selecting a course learning difficulty and a course learning target as required. The above steps are combined with subjectivity and passivity to integrally and dynamically generate personalized courses. Each class can make a selection, so as to meet ever-changing learning needs of the student.

### BRIEF DESCRIPTION OF THE DRAWINGS

FIG. 1 is an overall flow chart of the present disclosure.

FIG. 2 is a schematic diagram of a method of classifying a textbook difficulty according to the present disclosure.

FIG. 3 is a schematic diagram of a method of calibrating a learning target according to the present disclosure.

FIG. 4 is a schematic diagram of a method of scoring the learning ability according to the present disclosure.

FIG. 5 is a schematic diagram of a method of dynamically generating a personalized knowledge graph according to the present disclosure.

### DETAILED DESCRIPTION OF THE EMBODIMENTS

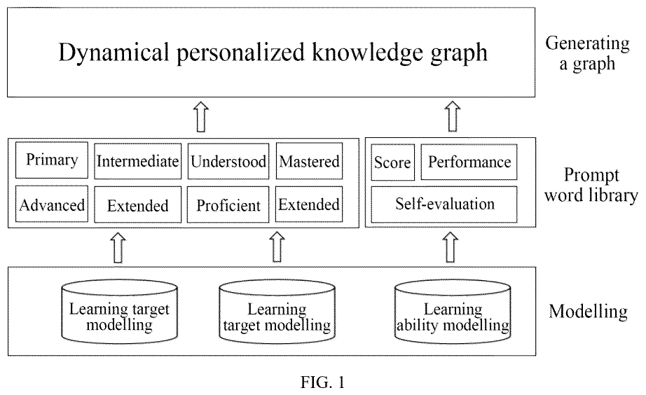

As an embodiment of the present disclosure, as shown in FIG. 1, a method of dynamically generating a personalized knowledge graph based on prompt learning is provided, including the following steps:
S1, constructing a prompt word library, wherein the prompt word library includes: difficulty prompt words, wherein the difficulty prompt words are indicated as primary, intermediate, advanced or extended; and learning target prompt words, wherein the learning target prompt words are indicated as understood, mastered, proficient or/and extended; wherein the difficulty prompt words are obtained by the following steps:
S111, acquiring a target textbook and teaching plans of the target textbook from a teacher over the years;
S112, dividing textbook knowledge points according to the target textbook and the teaching plans;
S113, defining an importance and a calculating rule of the textbook knowledge points, a common sense and a calculating rule of the textbook knowledge points, and an emphasis and a calculating rule of the teaching plans;
S114, obtaining the importance of the textbook knowledge points, the common sense of the textbook knowledge points and the emphasis of the teaching plans according to the above calculating rules, and giving a difficulty classification of the textbook knowledge points: primary, intermediate, advanced or/and extended to obtain the difficulty prompt words;
the learning target prompt words are obtained by the following steps:
S121, acquiring the teaching plans of the target textbook from the teacher over the years;
S122, extracting a teaching target of each class hour in the teaching plan;
S123, converting the teaching target into a learning target to obtain learning target prompt words;
S2, evaluating the learning ability of students, wherein the evaluation method includes the following steps:
S211, acquiring a written score C_a, a usual score N_a and a self-evaluation S e of students;
S212, calculating a learning ability score S_a of students through a set evaluation calculating rule;
S3: giving a knowledge graph of the class according to prompt words selected by students, learning ability evaluation results and a set prompt mapping rule.

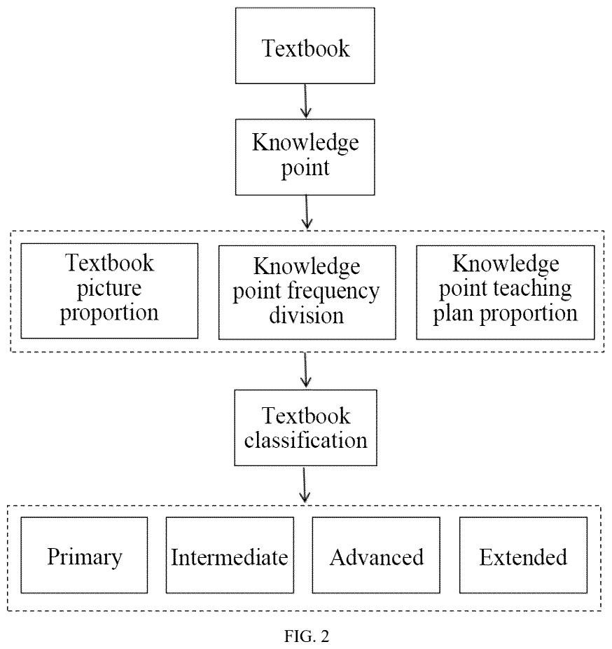

As an embodiment of the present disclosure, as shown in FIG. 2, as for the importance of the textbook knowledge points, the more writing length W of knowledge points in the target textbook and the more pictures P indicate the higher importance S of the knowledge points, and the calculating rule of the importance S is as follows:
given that the total length of the textbook is M, the total length of characters is T_s and the total length of pictures is P_s, a writing length coefficient is

$$a = \frac{T\_s}{M} ,$$

and a picture proportion coefficient is

$$b = \frac{p\_s}{M} ;$$

if the writing length of a knowledge point is W, and the number of pictures is P, the importance of the knowledge point is: S=aW+bP;
as for the common sense of the textbook knowledge points, the knowledge points with a higher using frequency are more familiar in this field, the knowledge points are defined as commonsense knowledge points; otherwise, the knowledge points are advanced knowledge points; and the calculating rule of the common sense C is as follows:

$$C = \{ \begin{matrix}0 , & commonsense knowledge points \\ 1 , & advanced knowledge points\end{matrix} ;$$

as for the emphasis of the teaching plans, in the teaching plans from many teachers over the years, the knowledge points in which the writing length has a higher proportion and the class hour has a higher proportion are the emphasis, and the calculating rule of the emphasis E is as follows:
given that the total length of the teaching plan is M, the total number of class hours is T, the writing length of a knowledge point is m, and the number of the occupied class hours is t, the length proportion is

$$M\_p = \frac{m}{M} ,$$

the class hour proportion is

$$T\_p = \frac{t}{T} ,$$

and the emphasis of the knowledge point is E=0.5*M_p+0.5*T_p.

A difficulty classifying standard of the textbook knowledge points is designed as follows:

$$\{ \begin{matrix}primary , C = 0 , Total ∈ [ 0 , 0.25 ] \\ intermediate , C = 0 , Total ∈ ( 0.25 , 0.5 ] \\ advanced , C = 1 , Total ∈ ( 0.5 , 0.75 ] \\ extended , C = 1 , Total ∈ ( 0.75 , 1 ]\end{matrix} , where Total = \frac{S + E}{2} .$$

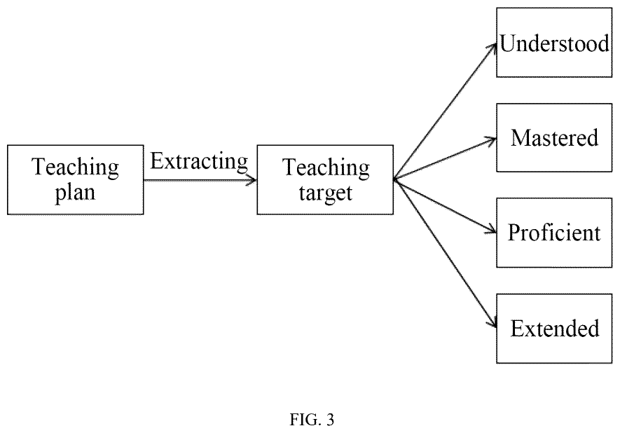

As an embodiment of the present disclosure, as shown in FIG. 3, the learning target prompt words are obtained by the following steps:
S121, acquiring the teaching plans of the target textbook from the teacher over the years;
S122, extracting a teaching target of each class hour in the teaching plan;
S123, converting the teaching target into a learning target to obtain learning target prompt words.

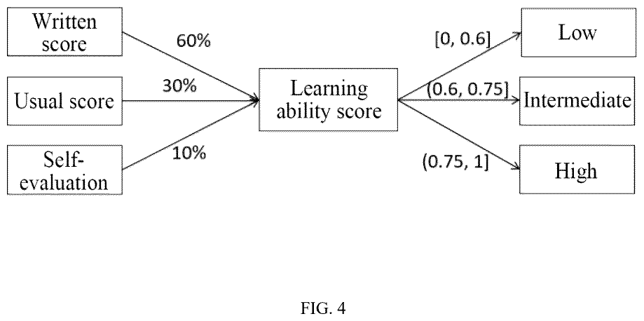

As an embodiment of the present disclosure, as shown in FIG. 4, the evaluation calculating rule is as follows: if the usual score accounts for 30%; the written score accounts for 60%, and the self-evaluation of the student accounts for 10%:

$$S\_a = 0.3 * N\_a + 0 \text{.6} * C\_a + 0 \text{.1} * S\_e ,$$

$$\{ \begin{matrix}low , S\_a ∈ [ 0 , 0.6 ] \\ intermediate , S\_a ∈ ( 0.6 , 0.75 ] . \\ high , {S}_{-} a ∈ ( 0.75 , 1 ]\end{matrix}$$

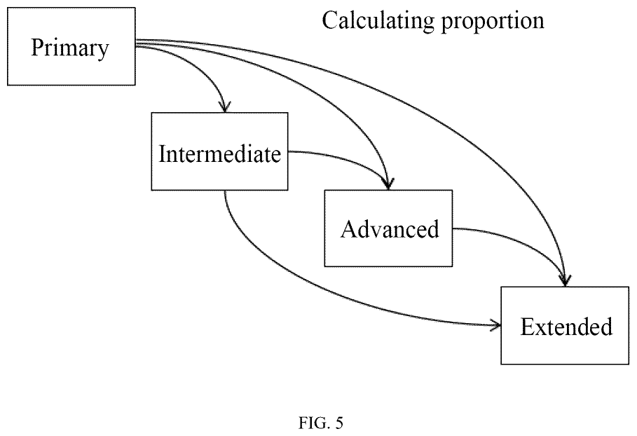

As an embodiment of the present disclosure, as shown in FIG. 5, the prompt mapping rule is designed as follows:
if a combination of the prompt words and the evaluation results is the permutation and combination of [primary, understood, low/intermediate/high], the knowledge points with primary difficulty level are directly selected to start, the knowledge graph of all primary knowledge points is generated according to the order of textbooks, and the combination of the prompt words and the learning time are recorded;
if the combination of the prompt words and the evaluation results is the permutation and combination of [intermediate, understood/mastered, intermediate/high], the knowledge graph is generated according to the knowledge point linking method, and the combination of the prompt words and the learning time are recorded;
if the combination of the prompt words and the evaluation results is the permutation and combination of [advanced, proficient/extended, high], the knowledge graph is generated according to the designed knowledge point linking method, and the combination of the prompt words and the learning time are recorded;
if the combination of the prompt words and the evaluation results is the permutation and combination of [extended, proficiency/extended, high], the knowledge graph is generated according to the designed knowledge point linking method, and the combination of the prompt words and the learning time are recorded;
if the prompt words and the evaluation results are other combinations than the above combination, students are advised to re-select or study in the order of textbooks, and the learning time is recorded.

As an embodiment of the present disclosure, the knowledge point linking method includes the following steps:
S611, counting the knowledge points to obtain a knowledge point set;
S612, classifying the knowledge points according to the difficulty level to obtain a primary knowledge point set P=[P₁, P₂, . . . , Pₚ], an intermediate knowledge point set I=[I₁, I₂, . . . , Iᵢ], an advanced knowledge point set A=[A₁, A₂, . . . , Aₐ], and an extended knowledge point set E=[E₁, E₂, . . . , Eₑ].
S613, calculating a frequency of the primary knowledge point P appearing in other knowledge points; similarly, calculating a frequency of the intermediate knowledge point I appearing in the advanced and extended knowledge points and a frequency of the advanced knowledge point A appearing in the extended knowledge points;
S614, linking the knowledge points according to a frequency result.

The technical scheme of the present disclosure has been described in detail above with reference to the embodiments/drawings, but the present disclosure is not limited to the above technical scheme. For those skilled in the art, after knowing the contents described in the present disclosure, several equivalent transformations and substitutions can be made without departing from the principle of the present disclosure, and these equivalent transformations and substitutions should also be regarded as belonging to the scope of protection of the present disclosure.

What is claimed is:

1. A method of dynamically generating a personalized knowledge graph based on prompt learning, wherein the method comprises the following steps:
S1, constructing a prompt word library, wherein the prompt word library comprises: difficulty prompt words, wherein the difficulty prompt words are indicated as primary, intermediate, advanced or extended; and learning target prompt words, wherein the learning target prompt words are indicated as understood, mastered, proficient or/and extended; wherein
the difficulty prompt words are obtained by the following steps:
S111, acquiring a target textbook and teaching plans of the target textbook from a teacher over the years;
S112, dividing textbook knowledge points according to the target textbook and the teaching plans;
S113, defining an importance and a calculating rule of the textbook knowledge points, a common sense and a calculating rule of the textbook knowledge points, and an emphasis and a calculating rule of the teaching plans;
S114, obtaining the importance of the textbook knowledge points, the common sense of the textbook knowledge points and the emphasis of the teaching plans according to the above calculating rules, and giving a difficulty classification of the textbook knowledge points: primary, intermediate, advanced or/and extended to obtain the difficulty prompt words;
the learning target prompt words are obtained by the following steps:
S121, acquiring the teaching plans of the target textbook from the teacher over the years;
S122, extracting a teaching target of each class hour in the teaching plan;
S123, converting the teaching target into a learning target to obtain learning target prompt words;
S2, evaluating the learning ability of students, wherein the evaluation method comprises the following steps:
S211, acquiring a written score C_a, a usual score N_a and a self-evaluation S_e of students;
S212, calculating a learning ability score S_a of students through a set evaluation calculating rule;
S3: giving a knowledge graph of the class according to prompt words selected by students, learning ability results and a set prompt mapping rule; wherein the mapping rule comprises a knowledge point linking method.

2. The method of dynamically generating the personalized knowledge graph based on prompt learning according to claim 1, wherein
as for the importance of the textbook knowledge points, the more writing length W of knowledge points in the target textbook and the more pictures P indicate the higher importance S of the knowledge points, and the calculating rule of the importance S is as follows:
given that the total length of the textbook is M, the total length of characters is T_s and the total length of pictures is P_s, a writing length coefficient is
$$a = \frac{T\_s}{M} ,$$
and a picture proportion coefficient is
$$b = \frac{p\_s}{M} ;$$
if the writing length of a knowledge point is W, and the number of pictures is P, the importance of the knowledge point is: S=aW+bP;
as for the common sense of the textbook knowledge points, the knowledge points with a higher using frequency are more familiar in this field, the knowledge points are defined as commonsense knowledge points; otherwise, the knowledge points are advanced knowledge points; and the calculating rule of the common sense C is as follows:
$$C = \{ \begin{matrix}0 , & commonsense knowledge points \\ 1 , & advanced knowledge points\end{matrix} ;$$
as for the emphasis of the teaching plans, in the teaching plans from many teachers over the years, the knowledge points in which the writing length has a higher proportion and the class hour has a higher proportion are the emphasis, and the calculating rule of the emphasis E is as follows:
given that the total length of the teaching plan is M, the total number of class hours is T, the writing length of a knowledge point is m, and the number of the occupied class hours is t, the length proportion is
$$M\_p = \frac{m}{M} ,$$
the class hour proportion is
$$T\_p = \frac{t}{T} ,$$
and the emphasis of the knowledge point is E=0.5*M_p+0.5*T_p.

3. The method of dynamically generating the personalized knowledge graph based on prompt learning according to claim 1, wherein a difficulty classifying standard of the textbook knowledge points is designed as follows:
$$\{ \begin{matrix}primary , C = 0 , Total ∈ [ 0 , 0.25 ] \\ intermediate , C = 0 , Total ∈ ( 0.25 , 0.5 ] \\ advanced , C = 1 , Total ∈ ( 0.5 , 0.75 ] \\ extended , C = 1 , Total ∈ ( 0.75 , 1 ]\end{matrix} , where Total = \frac{S + E}{2} .$$

4. The method of dynamically generating the personalized knowledge graph based on prompt learning according to claim 1, wherein the evaluation calculating rule is as follows: if the usual score accounts for 30%; the written score accounts for 60%, and the self-evaluation of the student accounts for 10%:
$$S\_a = 0.3 * N\_a + 0 \text{.6} * C\_a + 0 \text{.1} * S\_e ,$$
$$\{ \begin{matrix}low , S\_a ∈ [ 0 , 0.6 ] \\ intermediate , S\_a ∈ ( 0.6 , 0.75 ] . \\ high , {S}_{-} a ∈ ( 0.75 , 1 ]\end{matrix}$$

5. The method of dynamically generating the personalized knowledge graph based on prompt learning according to claim 1, wherein the prompt mapping rule is designed as follows:
if a combination of the prompt words and the evaluation results is the permutation and combination of [primary, understood, low/intermediate/high], the knowledge points with primary difficulty level are directly selected to start, the knowledge graph of all primary knowledge points is generated according to the order of textbooks, and the combination of the prompt words and the learning time are recorded;
if the combination of the prompt words and the evaluation results is the permutation and combination of [intermediate, understood/mastered, intermediate/high], the knowledge graph is generated according to the knowledge point linking method, and the combination of the prompt words and the learning time are recorded;
if the combination of the prompt words and the evaluation results is the permutation and combination of [advanced, proficient/extended, high], the knowledge graph is generated according to the designed knowledge point linking method, and the combination of the prompt words and the learning time are recorded;
if the combination of the prompt words and the evaluation results is the permutation and combination of [extended, proficiency/extended, high], the knowledge graph is generated according to the designed knowledge point linking method, and the combination of the prompt words and the learning time are recorded;
if the prompt words and the evaluation results are other combinations than the above combination, students are advised to re-select or study in the order of textbooks, and the learning time is recorded.

6. The method of dynamically generating the personalized knowledge graph based on prompt learning according to claim 5, wherein the knowledge point linking method comprises the following steps:
S611, counting the knowledge points to obtain a knowledge point set;
S612, classifying the knowledge points according to the difficulty level to obtain a primary knowledge point set P=[P₁, P₂, . . . , Pₚ], an intermediate knowledge point set I=[I₁, I₂, . . . , Iᵢ], an advanced knowledge point set A=[A₁, A₂, . . . , Aₐ], and an extended knowledge point set E=[E₁, E₂, . . . , Eₑ].
S613, calculating a frequency of the primary knowledge point P appearing in other knowledge points; similarly, calculating a frequency of the intermediate knowledge point I appearing in the advanced and extended knowledge points and a frequency of the advanced knowledge point A appearing in the extended knowledge points;
S614, linking the knowledge points according to a frequency result.
